(19) United States
(12) Patent Application Publication
(10) Pub. No.: US 2016/0378178 A1
(43) Pub. Date: Dec. 29, 2016

(54) VISUALIZED CONTENT TRANSMISSION CONTROL METHOD, SENDING METHOD AND APPARATUSES THEREOF

(71) Applicant: Beijing Zhigu Rui Tuo Tech Co., Ltd, Beijing (CN)

(72) Inventor: Na Wei, Beijing (CN)

(21) Appl. No.: 15/196,016

(22) Filed: Jun. 28, 2016

(30) Foreign Application Priority Data
Jun. 29, 2015 (CN) 201510367081.3

(51) Int. Cl. G06F 3/01

(52) U.S. Cl. CPC G06F 3/012; G06F 3/017; G06F 3/011

(57) ABSTRACT

A visualized content transmission control method, a visualized content sending method and apparatuses thereof are provided. A transmission control method comprises: acquiring information associated with a user gesture; and determining a sending strategy of visualized content associated with a target scene at least according to the information associated with the user gesture, wherein the sending strategy comprises: sending visualized content associated with the target scene in a direction corresponding to the user gesture to the user. By tracking a gesture change of the user viewing an immersive virtual reality display, the visualized content can be intelligently sent in a corresponding direction, which is favorable for providing better immersive virtual reality experience for the user and reducing pressure caused to a network.

### RELATED APPLICATION

The present application claims the benefit of priority to Chinese Patent Application No. 201510367081.3, filed on Jun. 29, 2015, and entitled “VISUALIZED CONTENT TRANSMISSION CONTROL METHOD, SENDING METHOD AND APPARATUSES THEREOF”, which application is hereby incorporated herein by reference in its entirety.

### TECHNICAL FIELD

The present application relates to an information acquiring technology, and, for example, to a visualized content transmission control method, sending method and apparatuses thereof.

### BACKGROUND

An immersive VR (virtual reality) technology is to synthesize multimedia content of one scene in multiple directions into a real time dynamic three-dimensional vivid display of such scene based on, for example, a helmet-mounted display (HMD)-based system, a projection virtual reality system, etc., so as to provide total immersive experience for a user, causing the user to have a feeling in a virtual world. For example, a special virtual reality camera with a plurality of high definition cameras shoots a panorama 360-degree 3D video of a target scene and transmits the video to a virtual reality display device (for example, an HMD and glasses) used by a user for performing immersive virtual reality video display.

For performing immersive virtual reality video display, a shooting device is required to shoot in multiple directions, for example, a high definition virtualized content in the multiple directions is captured by a plurality of high definition cameras, in order to realize better immersive virtual reality display, a 4K/8K ultrahigh definition visualized content can be captured, if such visualized content is transmitted in a streaming manner, there would be high requirements on a network transmission environment undoubtedly, for example, the network is required to provide larger bandwidth and faster network speed which cause lager pressure on the network.

### SUMMARY

An example non-limiting object of one or more embodiments of the present application is to provide a visualized content transmission solution, which does not influence user experience, while pressure to a network is greatly reduced.

In a first aspect, an example embodiment of the present application provides a visualized content transmission control method, comprising:

acquiring information associated with a user gesture; and

determining a sending strategy of visualized content associated with a target scene at least according to the information associated with the user gesture, wherein the sending strategy comprises: sending visualized content associated with the target scene in at least one direction corresponding to the user gesture to the user.

In a second aspect, an example embodiment of the present application provides a visualized content sending method, comprising:

acquiring information associated with a user gesture; and

sending visualized content associated with a target scene in at least one direction corresponding to the user gesture to the user at least according to the information associated with the user gesture.

In a third aspect, an example embodiment of the present application provides a presenting method, comprising:

acquiring visualized content sent according to a sending strategy, wherein the sending strategy is determined according to information associated with a user gesture, and comprises: sending visualized content associated with a target scene in at least one direction corresponding to the user gesture to the user; and

presenting immersive virtual reality display to the user at least according to the sending strategy.

In a fourth aspect, an example embodiment of the present application provides a visualized content transmission control apparatus, comprising:

a first acquiring module, configured to acquire information associated with a user gesture; and

a first determining module, configured to determine a sending strategy of visualized content associated with a target scene at least according to the information associated with the user gesture, wherein the sending strategy comprises: sending visualized content associated with the target scene in at least one direction corresponding to the user gesture to the user.

In a fifth aspect, an example embodiment of the present application provides a visualized content sending apparatus, comprising:

a third acquiring module, configured to acquire information associated with a user gesture; and

a third sending module, configured to send visualized content associated with a target scene in at least one direction corresponding to the user gesture to the user at least according to the information associated with the user gesture.

In a sixth aspect, an example embodiment of the present application provides a presenting apparatus, comprising:

a fourth acquiring module, configured to acquire visualized content sent according to a sending strategy, wherein the sending strategy is determined according to information associated with a user gesture, and comprises: sending visualized content associated with a target scene in at least one direction corresponding to the user gesture to the user; and a displaying module, configured to present immersive virtual reality display to the user at least according to the sending strategy.

In a seventh aspect, an example embodiment of the present application provides a visualized content transmission control apparatus, comprising:

a video camera, comprising a plurality of cameras;

a memory, configured to store a command;

a processor, configured to execute the command stored by the memory, wherein the command enables the processor to execute following steps:

acquiring information associated with a user gesture; and

determining a sending strategy of visualized content associated with a target scene at least according to the information associated with the user gesture, wherein the sending strategy comprises: sending visualized content associated with the target scene in at least one direction corresponding to the user gesture to the user by at least one of the plurality of cameras.

In an eighth aspect, an example embodiment of the present application provides a presenting apparatus, comprising:

a display;

a memory, configured to store a command; and

a processor, configured to execute the command stored by the memory, wherein the command enables the processor to execute following steps:

acquiring visualized content sent according to a sending strategy, wherein the sending strategy is determined according to information associated with a user gesture, and comprises: sending visualized content associated with a target scene in at least one direction corresponding to the user gesture to the user; and

presenting immersive virtual reality display to the user at least according to the sending strategy.

According to the methods and apparatuses of example embodiments of the present application, by tracking a gesture change of the user viewing an immersive virtual reality display, the visualized content in a corresponding direction can be intelligently sent, which is favorable for providing better immersive virtual reality experience for the user and reducing pressure caused to a network.

### BRIEF DESCRIPTION OF THE DRAWINGS

FIG. 1 is a flow chart of a visualized content transmission control method according to an example embodiment of the present application;

FIG. 2 is a flow chart of a visualized content sending method according to an example embodiment of the present application;

FIG. 3 is a flow chart of a presenting method according to an example embodiment of the present application;

FIG. 4(a) to FIG. 4(c) are structural diagrams of a plurality of examples of a visualized content transmission control apparatus according to an example embodiment of the present application;

FIG. 5(a) to FIG. 5(b) are structural diagrams of a plurality of examples of a visualized content sending apparatus according to an example embodiment of the present application;

FIG. 6(a) to FIG. 6(d) are structural diagrams of a plurality of examples of a presenting apparatus according to an example embodiment of the present application;

FIG. 7 is a structural diagram of another example of a visualized content transmission control apparatus according to an example embodiment of the present application;

FIG. 8 is a structural diagram of another example of a visualized content sending apparatus according to an example embodiment of the present application; and

FIG. 9 is a structural diagram of another example of a presenting apparatus according to an example embodiment of the present application.

### DETAILED DESCRIPTION

The following further describes example embodiments of the present application in detail in combined with drawings (same numbers in the plural drawings denote same elements) and embodiments. The following embodiments intend to describe the present application rather than limiting a scope of the present application.

Those skilled in the art should understand that the terms such as “first” and “second” in the present application merely intend to differentiate different steps, equipment or modules, and represent neither any specific technical meaning nor a necessary logic sequence among them.

In order to better understand the present application, terms used in the embodiments of the present application are explained:

“Visualized content” is any content in a target scene to be presented in an immersive virtual reality manner, the content comprises any physical object related to the target scene and/or digital (virtual) object. Sending and transmitting of the visualized content refer to sending of any related data of the corresponding visualized content to be presented in the immersive virtual reality manner from a capturing unit side and transmitting to a target user side by a wireless network, such data comprises but is not limited to: any visualized content-related character, picture, image, audio file and video file and described data related to virtual reality presenting of any physical and/or virtual object in the target scene, for example, a three dimensional model, space relation described data and the like, and these data can be transmitted in a streaming manner. “Target scene” comprises a real physical environment, a virtual reality environment (virtual environment) and a mixed reality environment (comprising augmented reality and augmented virtual reality that is, mixing of the physical environment and the virtual environment). “capturing unit” refers to an apparatus or a part of the apparatus configured to capture data associated with virtualized content of the target scene, for example, the capturing unit is a device with a plurality of cameras, or any camera with a device having a plurality of cameras, and configured to capture data of visualized content associated with a real physical environment and/or acquire data of visualized content in a virtual reality scene/mixed reality scene.

By utilizing immersive virtual reality display devices, such as a helmet-mounted display, glasses, a projection device of a projection virtual reality system and others, to receive in real time and process the visualized content associated with the target scene captured/acquired by one or more capturing units through a wireless network, it is possible to provide the user with an immersive virtual reality viewing experience of the target scene for the user. Based on research, the user being immersed within realistic simulation environment maybe change gestures as the real time changes within the scene, for example, the head, eyes or other possible body parts make actions, based on which, the embodiments of the present application selectively perform visualized content transmission by tracking and predicting the gesture change of the user, thereby providing a better immersive virtual reality experience and greatly reducing the pressure caused to the network.

FIG. 1 is a flow chart of a visualized content transmission control method according to an embodiment of the present application, and the method can be executed by any capturing unit, can also be executed by an independent apparatus, and as shown in FIG. 1, comprises:

S120: Acquire information associated with a user gesture.

In the method of this embodiment, the information associated with the user gesture refers to any information capable of representing a state and/or viewing intention of the user when the user is viewing the immersive virtual reality display, and the information comprises but is not limited to a user facing direction, a user head rotation speed, a user head horizontal angle and a user head tilt angle.

S140: Determine a sending strategy of visualized content associated with a target scene at least according to the information associated with the user gesture, wherein the sending strategy comprises: sending visualized content associated with the target scene in at least one direction corresponding to the user gesture to the user.

As mentioned above, in Step 140, a state and/or viewing intention of the user in the immersive virtual reality viewing process can be determined based on the information acquired according to S120, for example, a viewing direction of the user can be determined according to the user gesture, thereby a corresponding sending strategy can be determined, that is, it is determined to send visualized content associated with the target scene in the direction corresponding to a user gesture to the user. The visualized content in that direction may be the content captured/acquired by one or more capturing units.

To sum up, according to the method of this embodiment, by tracking a gesture change of the user viewing an immersive virtual reality display, a corresponding sending strategy of the visualized content can be determined, which is favorable for providing better immersive virtual reality experience for the user and reducing pressure caused to a network.

It should be noted that since the visualized content may be continuously transmitted in a period, the S120 can be executed periodically, in real time, in respond to the user gesture change, or according to a network transmission capacity (if the network transmission capacity is good, triggering the execution frequently, if not, triggering the execution less frequently), and correspondingly, in S140, an adaptive change of the sending strategy can be made according to the information change acquired in S120.

In addition, as abovementioned, a user viewing direction can be determined according to the user gesture to further make a corresponding strategy, therefore, S140 can further comprise:

S142: Determine the at least one direction at least according to the information associated with the user gesture.

Determining the user viewing direction determined according to the user gesture is a relative mature technology and is not repeated here. The at least one direction is preferably a direction same or similar with the user viewing direction.

In the method of this embodiment, sending visualized content associated with the target scene in the at least one direction corresponding to the user gesture sent to the user and involved in the sending strategy can comprise: only sending the visualized content associated with the target scene in the at least one direction, thereby saving bandwidth would otherwise be used for sending visualized content in multiple directions, thereby transmitting the visualized content in the at least one direction with a higher transmission quality (for example, resolution, transmission rate, etc.). The sending strategy can also clearly indicate that sending visualized content associated with the target scene in the at least one direction is sent to the user with a preset priority, specifically, the sending strategy can comprise: second the visualized content associated with the target scene in the at least one direction corresponding to the user gesture to the user with a higher priority. The higher priority comprises but is not limited to higher sending frequency priority, sending time priority, transmission quality priority and the like, that is, compared with the visualized content in other directions, the visualized content associated with the target scene in the at least one direction corresponding to the user gesture can be sent earlier, more frequently within a unit time and/or with higher transmission quality, thus ensuring user experience.

In addition, in the example embodiment of only sending the visualized content in the at least one direction, the capturing unit may be controlled to only capture/acquire data of visualized content of a target scene in the at least one direction and send it, or the capturing unit may be controlled to capture/acquire data of visualized content associated with the target scene in multiple directions including the at least one direction but only send the visualized content of the target scene in the at least one direction only.

In the example embodiment of sending the visualized content in multiple directions including the at least one direction according to the preset priority, in the method of this embodiment, a plurality of capturing units may be controlled to respectively capture/acquire data of visualized content of the target scene in multiple directions and send the data according to the preset priority.

As abovementioned, in the method of this embodiment, only the visualized content of the target scene in the at least one direction may be acquired and sent, and in such an example embodiment, in the method of this embodiment further comprises:

S161: Acquire the visualized content associated with the target scene in the at least one direction at least according to the sending strategy.

The sending strategy clarifies that the visualized content to be sent to the user is the content in the at least one direction, in S161, the visualized content can be acquired by communicating with a corresponding at least one capturing unit, or by positively capturing the visualized content of the target scene in the at least one direction.

S162: Send the visualized content associated with the target scene in the at least one direction to the user. Specifically, in S162, the visualized content is sent to a device, for example a helmet mounted display, glasses, etc., worn by the user, for presenting immersive virtual reality display at user side.

Still as abovementioned, in the method of this embodiment, the visualized content associated with the target scene in multiple directions can be acquired and the visualized content associated with the target scene in at least one direction can be sent. In such an example embodiment, the method of this embodiment further comprises:

S163: Acquire visualized content associated with the target scene in at least two directions at least according to the sending strategy, wherein the at least two directions comprise the at least one direction.

As described in combination with S161, the visualized content can be acquired by communicating with at least one capturing unit corresponding to each direction, or positively capturing the visualized content of the target scene in the at least one direction.

S164: Send the visualized content associated with the target scene in the at least one direction to the user. Specifically, in S164, the visualized content is sent to a device, for example a helmet mounted display, glasses, etc., worn by the user, for presenting immersive virtual reality display at user side.

Further as abovementioned, the sending strategy further comprises: sending the visualized content associated with the target scene in the at least two directions to the user at least according to a preset priority, wherein the at least two directions comprise the at least one direction. In such an example embodiment, the method of this embodiment further comprises:

S165: Acquire the visualized content associated with the target scene in the at least two directions at least according to the sending strategy.

As described in combination with S161, in S165, the visualized content can be acquired by communicating with at least one capturing unit corresponding to each direction, or by positively capturing the visualized content of the target scene in the at least one direction.

S166: Send the visualized content associated with the target scene in the at least two directions according to the preset priority. Specifically, in S166, the visualized content is sent to a device, for example a helmet mounted display, glasses, etc., worn by the user, for presenting immersive virtual reality display at user side.

In addition, in an immersive virtual reality scenario, the user gesture can be tracked by a plurality of sensors, in the method of the embodiment, information associated with the user gesture can be acquired from the at least one sensor associated with the user, the at least one sensor is arranged on the helmet mounted display, glasses, etc., worn by the user. Therefore, S120 can comprise:

S122: Receive the information of the at least one sensor associated with the user. The information can be raw sensor data sensed by each sensor or a definite user gesture determined according to the sensor data sensed by each sensor.

In order to realize transmitting of the visualized content and presenting the immersive virtual reality display to the user, the method of this embodiment further comprises:

S180: Send information associated with the sending strategy.

In the method of this embodiment, in S180, the sending strategy can be sent in a manner that each capturing unit can receive it, and/or a manner that a display device used by the user can receive it.

In the method of this embodiment, compared with the visualized content to be sent for forming the virtual reality display, the information associated with the user gesture and sending strategy can be sent in smaller data packets with low transmission requirements, through such tracking feedback mechanism, the visualized content can be transmitted in a more intelligent manner, and better immersive experience is provided for the user even under the condition of a limited bandwidth.

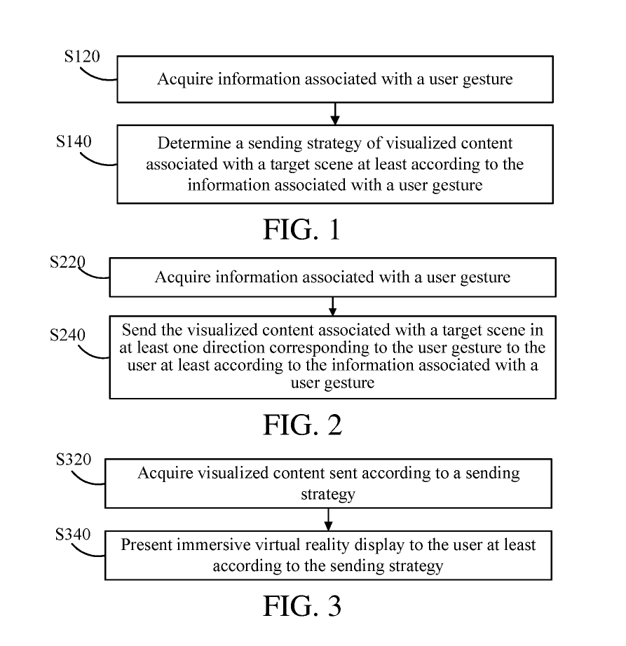

The present application further provides a visualized content sending method, and the method can be executed by any capturing unit. FIG. 2 is a flow chart of a visualized content sending method according to an embodiment of the present application. As shown in FIG. 2, the method comprises:

S220: Acquire information associated with a user gesture.

In the method of this embodiment, the information associated with the user gesture refers to any information capable of representing a state and/or viewing intention of the user when the user is viewing the immersive virtual reality display, and the information comprises but is not limited to a user facing direction, a user head rotation speed, a user head horizontal angle and a user head tilt angle.

S240: Send visualized content associated with a target scene in at least one direction corresponding to the user gesture to the user at least according to the information associated with the user gesture.

As mentioned above, in Step 240, a state and/or viewing intention of the user in the immersive virtual reality viewing process can be determined based on the information acquired according to S220, for example, a viewing direction of the user can be determined according to the user gesture, thereby sending visualized content associated with the target scene in the direction corresponding to the user gesture to the user. The visualized content in that direction may be the content captured/acquired by one or more capturing units. In the example embodiment of capturing by a plurality of capturing units, the method of this embodiment, corresponding visualized content may be acquired by communicating with each capturing unit and send in a unified manner.

To sum up, according to the method of this embodiment, by tracking a gesture change of the user viewing an immersive virtual reality display, the visualized content in a corresponding direction can be sent to the user, which is favorable for providing better immersive virtual reality experience for the user and reducing pressure caused to a network.

It should be noted that since the visualized content may be continuously transmitted in a period, the S220 can be executed by periodically, in real time, in respond to the user gesture change, or according to a network transmission capacity (if the network transmission capacity is good, triggering the execution frequently, if not, triggering the execution less frequently), and correspondingly, in S240, an adaptive change of the sending strategy can be made according to the information change acquired in S220.

In addition, as abovementioned, the viewing direction of the user can be determined according to the user gesture, and the direction corresponding to the sent visualized content is determined, that is, S240 can further comprise:

S241: Determine the at least one direction at least according to the information associated with the user gesture.

Determining the user viewing direction determined according to the user gesture is a relative mature technology and is not repeated here. The at least one direction is preferably a direction same or similar with the user viewing direction.

In the method of this embodiment, the visualized content associated with the target scene in the at least one direction corresponding to the user gesture sent to the user and involved in the sending strategy can comprise: only sending the visualized content associated with the target scene in the at least one direction, thereby saving bandwidth would otherwise be used for sending visualized content in multiple directions, thereby transmitting the visualized content in the at least one direction with a higher transmission quality (for example, resolution, transmission rate, etc.). The visualized content associated with the target scene in the at least one direction is sent to the user with a preset priority, for example, the visualized content associated with the target scene in the at least one direction corresponding to the user gesture is sent to the user with a higher priority. The higher priority comprises but is not limited to higher sending frequency priority, sending time priority, transmission quality priority and the like, that is, compared with the visualized content in other directions, the visualized content associated with the target scene in the at least one direction corresponding to the user gesture can be sent earlier, more frequently within a unit time and/or with higher transmission quality, thus ensuring user experience.

In addition, in the example embodiment of only sending the visualized content in the at least one direction, the capturing unit may be controlled to only capture/acquire data associated with visualized content of a target scene in the at least one direction and send it, or control the capturing unit may be controlled to capture/acquire data of visualized content associated with the target scene in multiple directions including the at least one direction but only send the visualized content of the target scene in the at least one direction only.

In the example embodiment of sending the visualized content in multiple directions including the at least one direction according to the preset priority, in the method of this embodiment, a plurality of capturing units may be controlled to respectively capture/acquire data of visualized content of the target scene in multiple directions and send the data according to the preset priority.

As abovementioned, in the method of this embodiment, only the visualized content of the target scene in the at least one direction may be acquired and sent, and in such an example embodiment, S240 can further comprise:

S242: Acquire the visualized content associated with the target scene in the at least one direction.

In S242, the visualized content can be acquired by using the capturing unit, executing the method of this embodiment, to directly capture the visualized content associated with the target scene in the at least one direction, or the visualized content can be acquired by communicating with a corresponding at least one capturing unit.

S243: Send the visualized content associated with the target scene in the at least one direction to the user. Specifically, in S243, the visualized content is sent to a device, for example a helmet mounted display, glasses, etc., worn by the user, for presenting immersive virtual reality display at user side.

Still as abovementioned, in the method of this embodiment, the visualized content associated with the target scene in multiple directions can be acquired and the visualized content associated with the target scene in at least one direction can be sent. In such an example embodiment, S240 can further comprise:

S244: Acquire visualized content associated with the target scene in the at least two directions, wherein the at least two directions comprise the at least one direction.

As described in combination with S242, in S244, the visualized content can be acquired by communicating with at least one capturing unit corresponding to each direction, or by positively capturing the visualized content of the target scene in the at least one direction.

S245: Send the visualized content associated with the target scene in the at least one direction to the user. Specifically, in S245, the visualized content is sent to a device, for example a helmet mounted display, glasses, etc., worn by the user, for presenting immersive virtual reality display at user side.

Further as abovementioned, the sending strategy further comprises: sending visualized content associated with the target scene in the at least two directions to the user at least according to a preset priority, wherein the at least two directions comprise the at least one direction. In such an example embodiment, S240 can further comprise:

S246: Acquire the visualized content associated with the target scene in the at least two directions.

As described in combination 244, in S246, the visualized content can be acquired by communicating with at least one capturing unit corresponding to each direction, or by positively capturing the visualized content of the target scene in the at least one direction.

S247: Send the visualized content associated with the target scene in the at least two directions according to the preset priority. Specifically, in S247, the visualized content is sent to a device, for example a helmet mounted display, glasses, etc., worn by the user, for presenting immersive virtual reality display at user side.

In addition, in an immersive virtual reality scenario, the user gesture can be tracked by a plurality of sensors, in the method of the embodiment, information associated with the user gesture can be acquired from the at least one sensor associated with the user, the at least one sensor is arranged on the helmet mounted display, glasses, etc., worn by the user. Therefore, S220 can comprise:

S222: Receive the information of the at least one sensor associated with the user. The information can be raw sensor data sensed by each sensor or a definite user gesture determined according to the sensor data sensed by each sensor.

In conclusion, in the method of this embodiment, compared with the visualized content to be sent used for forming the virtual reality display, the information associated with the user gesture and sending strategy can be sent in smaller data packets with low transmission requirements, through such tracking feedback mechanism, the visualized content can be transmitted in a more intelligent manner, and better immersive experience is provided for the user even under the condition of a limited bandwidth.

The present application further provides a presenting method, and the method can be execute by an immersive virtual reality display device, comprising but not limit to a helmet mounted display, a projection device of a projection virtual reality system, etc. FIG. 3 is a flow chart of a presenting method according to an embodiment of the present application. As shown in FIG. 3, the method comprises:

S320: Acquire visualized content sent according to a sending strategy, wherein the sending strategy is determined according to information associated with a user gesture, and comprises: sending visualized content associated with a target scene in at least one direction corresponding to the user gesture to the user.

As described in combination with FIG. 1, in order to more intelligently send the visualized content, a capturing unit sends the visualized content according to certain sending strategy. The method in this embodiment acquires such visualized content.

S340: Present immersive virtual reality display to the user at least according to the sending strategy.

The sending strategy clarifies that the sent visualized content is related to a state and/or intention in a process that a user views the immersive virtual reality display, and therefore the method in this embodiment can provide better experience for the user.

Specifically, in order to more intelligently present the immersive virtual reality display for the user, the method in this embodiment can further comprise:

S310: Acquire information associated with the sending strategy. For example, the information associated with the sending strategy sent from an apparatus executing the method in the embodiment described in FIG. 1 is received.

As described in FIG. 1, in an example embodiment, in order to save bandwidth would otherwise be used for sending visualized content in multiple directions, thereby transmitting the visualized content in the at least one direction with higher transmission quality, the sending strategy clearly denotes: only sending the visualized content associated with the target scene in the at least one direction. In such an example embodiment, S340 further comprises:

S342: Determine the at least one direction at least according to the sending strategy.

S343: Present the immersive virtual reality to the user at least according to visualized content in the at least one direction acquired at a latest moment and visualized content in other directions acquired at a previous moment.

In order to provide immersive experience, visualized content in multiple directions may be required to be combined when the immersive virtual reality display is formed, therefore, in S343, in addition to the visualized content in the at least one direction, historical data can be used as the corresponding visualized content in other directions, thus ensuring the real time and/or high quality in a user viewing direction while ensuring the immersive experience.

In another example embodiment, the sending strategy can further clearly denote: sending the visualized content associated with the target scene in the at least one direction to the user according to a preset priority, and specifically, the sending strategy can comprise: sending the visualized content associated with the target scene in the at least one direction corresponding to the user gesture with higher priority. The higher priority comprises but is not limited to higher sending frequency priority, sending time priority, transmission quality priority and the like, that is, compared with the visualized content in other directions, the visualized content associated with the target scene in the at least one direction can be sent earlier, and more frequently within a unit time and/or with higher transmission quality, thus ensuring user experience.

In such an example embodiment, S340 can further comprise:

S344: Determine the preset priority at least according to the sending strategy.

S345: Present the immersive virtual reality to the user according to the preset priority.

In an example embodiment, an apparatus executing the method of this embodiment can determine a direction in which the visualized content can be acquired according to the preset priority, and combines with the historical data in other directions to present the immersive virtual reality to the user.

In addition, in order to provide a reference determining the sending strategy, the method of this embodiment further comprises:

S312: Capture information associated with a user gesture, wherein in an example embodiment, the user gesture is captured by at least one sensor, and in one example embodiment, the at least one sensor is the apparatus capable of executing the method of this embodiment.

S314: Send the information associated with the user gesture, wherein the information can be raw sensor data sensed by each sensor or a definite user gesture determined according to the sensor data sensed by each sensor. In S314, the apparatus executing the method as described in FIG. 1 and/or the apparatus executing the method as described in FIG. 2 can send the information in a manner that the first information can be received.

It should be noted that the method in this embodiment can adopt any proper technology, provide virtual reality display for the use based on the acquired visualized content and is not limitative to technical solutions of the embodiment of the present application.

In conclusion, the method in this embodiment can provide well immersive virtual reality viewing experience for the user.

Those skilled in the art should understand that in above method of example embodiments of the present application, numbers of respective steps do not mean an executing sequence, and the executing sequence should be determined by functions and an inherent logic of the steps without forming any limitation to an implementing process of example embodiments of the present application.

In addition, an embodiment of the present application further provides a computer readable medium, comprising a computer readable command which is executed to perform following operations: operations of all steps of the method in the example embodiment as shown in FIG. 1.

In addition, an embodiment of the present application further provides a computer readable medium, comprising a computer readable command which is executed to perform following operations: operations of all steps of the method in the example embodiment as shown in FIG. 2.

In addition, an embodiment of the present application further provides a computer readable medium, comprising a computer readable command which is executed to perform following operations: operations of all steps of the method in the example embodiment as shown in FIG. 3.

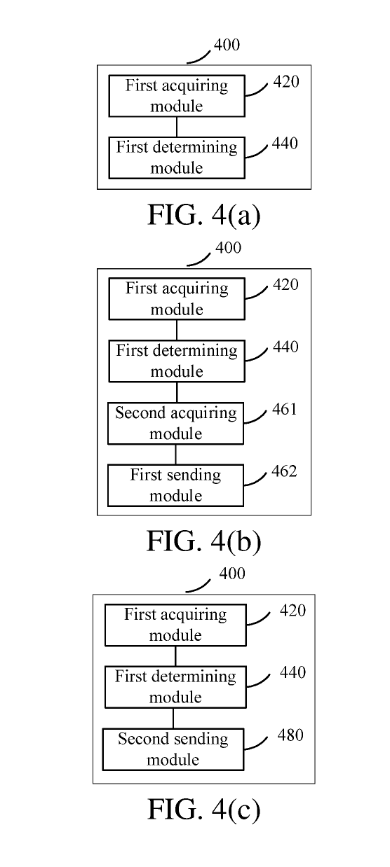

An embodiment of the present application further provides a visualized content transmission control apparatus executing the visualized content transmission control method as described in combination with FIG. 1, the apparatus can be an independent apparatus or belong to any capturing unit. Besides each constituting part described below, the apparatus can further comprise a communicating module capable of communicating with any external device as required. As shown in FIG. 4(a), a visualized content transmission control apparatus 400 according to a first embodiment of the present application comprises:

a first acquiring module 420, configured to acquire information associated with a user gesture.

In the apparatus of this embodiment, the information associated with the user gesture refers to any information capable of representing a state and/or viewing intention of the user when the user is viewing the immersive virtual reality display, and the information comprises but is not limited to a user facing direction, a user head rotation speed, a user head horizontal angle and a user head tilt angle.

A first determining module 440, configured to determine a sending strategy of visualized content associated with a target scene at least according to the information associated with the user gesture, wherein the sending strategy comprises: sending visualized content associated with the target scene in at least one direction corresponding to the user gesture to the user.

As abovementioned, the first determining module 440 can determine a state and/or viewing intention of the user in the immersive virtual reality viewing process based on the information acquired by the first acquiring module 420, for example, determine a viewing direction of the user according to the user gesture, thereby determining a corresponding sending strategy, that is to send the visualized content associated with the target scene in the direction corresponding to the user gesture to the user. The visualized content in that direction can be captured/acquired by one or more capturing units.

To sum up, according to the apparatus of this embodiment, by tracking a gesture change of the user viewing an immersive virtual reality display, a corresponding sending strategy of the visualized content can be determined, which is favorable for providing better immersive virtual reality experience for the user and reducing pressure caused to a network.

It should be noted that since the visualized content may be continuously transmitted in a period, the first acquiring module 420 can execute its functions periodically, in real time, in respond to the user gesture change, or according to a network transmission capacity (t if the network transmission capacity is good, triggering the execution frequently, if not, triggering the execution less frequently), and correspondingly, the first determining module 440 can make an adaptive change of the sending strategy according to the information change acquired by the first acquiring module 420.

In addition, as abovementioned, the user viewing direction can be determined according to the user gesture to further make a corresponding strategy, therefore, the first determining module can determine the at least one direction at least according to the information associated with the user gesture.

Determining the user viewing direction determined according to the user gesture is a relative mature technology and is not repeated here. The at least one direction is preferably a direction same or similar with the user viewing direction.

In the apparatus of this embodiment, the visualized content associated with the target scene in the at least one direction corresponding to the user gesture sent to the user and involved in the sending strategy can comprise: only sending the visualized content associated with the target scene in the at least one direction, thereby saving a bandwidth would otherwise be used for sending the visualized content in multiple directions, thereby transmitting the visualized content in the at least one direction with a higher transmission quality (for example, resolution, transmission rate, etc.). The sending strategy can also clearly indicate that sending visualized content associated with the target scene in the at least one direction is sent to the user with a preset priority, specifically, the sending strategy can comprise: sending the visualized content associated with the target scene in the at least one direction corresponding to the user gesture to the user with a higher priority. The higher priority comprises but is not limited to higher sending frequency priority, sending time priority, transmission quality priority and the like, that is, compared with the visualized content in other directions, the visualized content associated with the target scene in the at least one direction corresponding to the user gesture can be sent earlier, more frequently within a unit time and/or with higher transmission quality, thus ensuring user experience.

In addition, in the example embodiment of only sending the visualized content in the at least one direction, the apparatus in this embodiment can control the capturing unit to only capture/acquire data of visualized content of a target scene in the at least one direction and send the data, or control the capturing unit to capture/acquire data of visualized content of the target scene in multiple directions including the at least one direction but only send the visualized content of the target scene in the at least one direction only.

In the example embodiment of sending the visualized content in multiple directions including the at least one direction according to the preset priority, the apparatus of this embodiment can control a plurality of capturing units to respectively capture/acquire data of visualized content of the target scene in multiple directions and send the data according to the preset priority.

As shown in FIG. 4b), the apparatus 400 of the present apparatus further comprises: a second acquiring module 461 and a first sending module 462.

As abovementioned, the apparatus in this embodiment can only acquire and send the visualized content of the target scene in the at least one direction, and in such an example embodiment:

The second acquiring module 461 is configured to acquire the visualized content associated with the target scene in the at least one direction at least according to the sending strategy.

The sending strategy clarifies that the visualized content to be sent to the user is the content in the at least one direction, the second acquiring module 461 can acquire the visualized content by communicating with a corresponding at least one capturing unit, or by positively capturing the visualized content of the target scene in the at least one direction.

The first sending module 462 is configured to send the visualized content associated with the target scene in the at least one direction to the user. Specifically, the first sending module 462 sends the visualized content to a device, for example a helmet mounted display, glasses, etc., worn by the user, for presenting immersive virtual reality display at user side.

Still as abovementioned, the apparatus of this embodiment can acquire the visualized content associated with the target scene in multiple directions and send the visualized content associated with the target scene in at least one direction. In such an example embodiment:

the second acquiring module 461 is configured to acquire visualized content associated with the target scene in the at least two directions at least according to the sending strategy, wherein the at least two directions comprise the at least one direction.

Similarly, the second acquiring module 461 can acquire the visualized content by communicating with at least one capturing unit corresponding to each direction, or by positively capturing the visualized content of the target scene in the at least one direction.

The first sending module 462 is configured to send visualized content associated with the target scene in the at least one direction to the user. Specifically, the first sending module 462 sends the visualized content to a device, for example a helmet mounted display, glasses, etc., worn by the user, for presenting immersive virtual reality display at user side.

Further as abovementioned, the sending strategy further comprises: sending the visualized content associated with the target scene in the at least two directions to the user at least according to a preset priority, wherein the at least two directions comprise the at least one direction. In such an example embodiment:

The second acquiring module 461 is configured to acquire visualized content associated with the target scene in the at least two directions at least according to the sending strategy.

Similarly, the second acquiring module 461 can acquire the visualized content by communicating with at least one capturing unit corresponding to each direction, or by positively capturing the visualized content of the target scene in the at least one direction.

The first sending module 462 is configured to send the visualized content associated with the target scene in the at least two directions according to the preset priority. Specifically, the first sending module 462 sends the visualized content to a device, for example a helmet mounted display, glasses, etc., worn by the user, for presenting immersive virtual reality display at user side.

In addition, in an immersive virtual reality scenario, the user gesture can be tracked by a plurality of sensors, the apparatus of the embodiment can acquire the information associated with the user gesture from the at least one sensor associated with the user, that is, the first acquiring module 420 receives the information of the at least one sensor associated with the user. The information can be original sensor data sensed by each sensor or a definite user gesture determined by the sensor data sensed by each sensor.

In order to realize transmitting of the visualized content and presenting the immersive virtual reality display to the user, the apparatus 400 in FIG. 4c) further comprises:

a second sending module 480, configured to send information associated with the sending strategy.

In the apparatus in this embodiment, the second sending module 480 can send the sending strategy in a manner that each capturing unit can receive, and/or a manner that a display device used by the user can receive.

In the apparatus in this embodiment, compared with the visualized content to be sent used for forming the virtual reality display, the information associated with the user gesture and sending strategy can be sent in smaller data packets with low transmission requirements, through such tracking feedback mechanism, the visualized content can be transmitted in a more intelligent manner, and better immersive experience is provided for the user even under the condition of a limited wideband.

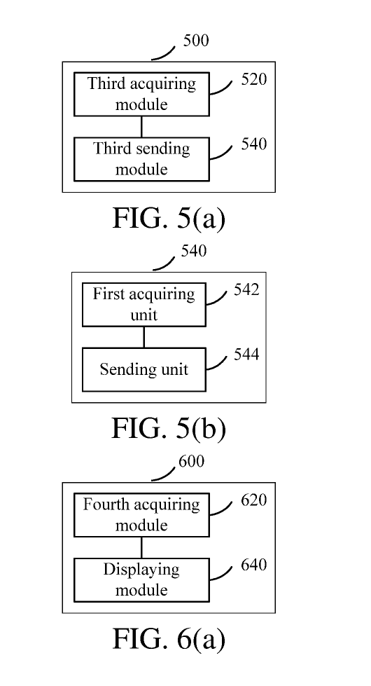

An embodiment of the present application further provides a visualized content transmission control apparatus executing the visualized content sending method as described in combination with FIG. 2, the apparatus can be an independent apparatus or belong to any capturing unit. Besides each constituting part described below, the apparatus can further comprise a communicating module capable of communicating with any external device as required. As shown in FIG. 5(a), a visualized content sending apparatus 500 comprises:

a third acquiring module 520, configured to acquire information associated with a user gesture.

In the apparatus of this embodiment, the information associated with the user gesture refers to any information capable of representing a state and/or viewing intention of the user when the user is viewing the immersive virtual reality display, and the information comprises but is not limited to a user facing direction, a user head rotation speed, a user head horizontal angle and a user head tilt angle.

A third sending module 540, configured to send visualized content associated with a target scene in at least one direction corresponding to a user gesture to the user at least according to the information associated with the user gesture.

As mentioned above, the third sending module 540 can determine a state and/or viewing intention of the user in the immersive virtual reality viewing process based on the information acquired by the third acquiring module 520, for example, determine a viewing direction of the user according to the user gesture, thereby determining a corresponding sending strategy; sending the visualized content associated with the target scene in the direction corresponding to the user gesture of to the user. The visualized content in that direction may be the content captured/acquired by one or more capturing units. In the example embodiment of capturing by a plurality of capturing units, the apparatus of this embodiment can acquire corresponding visualized content by communicating with each capturing unit and send in a unified manner.

To sum up, according to the apparatus of this embodiment, by tracking a gesture change of the user viewing an immersive virtual reality display, the visualized content in a corresponding direction can be sent to the user, which is favorable for providing better immersive virtual reality experience for the user and reducing pressure caused to a network.

It should be noted that since the visualized content may be continuously transmitted in a period, the third acquiring module 520 execute its functions periodically, in real time, in respond to the user gesture change, or according to a network transmission capacity (if the network transmission capacity is good, triggering the execution frequently, if not, triggering the execution less frequently), and correspondingly, the third sending module 540 can make an adaptive change of the sending strategy according to the information change acquired by the third acquiring module 520.

In addition, as abovementioned, the user viewing direction can be determined according to the user gesture to determine a direction corresponding to the sent visualized content, that is, the third sending module 540 can determine the at least one direction according to the information associated with the user gesture.

Determining the user viewing direction determined according to the user gesture is a relative mature technology and is not repeated here. The at least one direction is preferably a direction same or similar with the user viewing direction.

In the apparatus of this embodiment, the visualized content associated with the target scene in the at least one direction corresponding to the user gesture sent to the user and involved in the sending strategy can comprise: only sending the visualized content associated with the target scene in the at least one direction, thus saving a bandwidth would otherwise be used for sending the visualized content in multiple directions, thereby transmitting the visualized content in the at least one direction with a higher transmission quality (for example, resolution, transmission rate, etc.). The visualized content associated with the target scene in the at least one direction can be sent to the user with a preset priority, specifically, the visualized content associated with the target scene in the at least one direction is sent to the user with a preset priority. The higher priority comprises but is not limited to higher sending frequency priority, sending time priority, transmission quality priority and the like, that is, compared with the visualized content in other directions, the visualized content associated with the target scene in the at least one direction corresponding to the user gesture can be sent earlier, more frequently within a unit time and/or with higher transmission quality, thus ensuring user experience.

In addition, in the example embodiment of only sending the visualized content in the at least one direction, the apparatus in this embodiment can control the capturing unit to only capture/acquire data of visualized content associated with a target scene in the at least one direction and send the data, or control the capturing unit to capture/acquire data of visualized content associated with the target scene in multiple directions including the at least one direction but only send the visualized content of the target scene in the at least one direction only.

In the example embodiment of sending the visualized content in multiple directions including the at least one direction according to the preset priority, the apparatus in this embodiment can control a plurality of capturing units to respectively capture/acquire data of visualized content of the target scene in multiple directions and send the data according to the preset priority.

As shown in FIG. 5(b), the third sending module 540 can further comprise: a first acquiring unit 542 and a sending unit 544.

As abovementioned, the apparatus of this embodiment can only acquire and send the visualized content of the target scene in the at least one direction, and in such an example embodiment:

the first acquiring unit 542 is configured to acquire the visualized content associated with the target scene in the at least one direction.

The first acquiring unit 542 can acquire the visualized content in the at least one direction by positively capturing the visualized content of the target in the at least one direction, or acquire the visualized content by communicating with a corresponding at least one capturing unit.

The sending unit 544 is configured to send the visualized content associated with the target scene in the at least one direction to the user. Specifically, the sending unit 544 sends the visualized content to a device, for example a helmet mounted display, glasses, etc., worn by the user, for presenting immersive virtual reality display at user side.

Still as abovementioned, the apparatus of this embodiment can acquire visualized content of the target scene in multiple directions and only send the visualized content of the target scene in at least one direction. In such an example embodiment:

the first acquiring unit 542 is configured to acquire the visualized content associated with the target scene in the at least two directions, wherein the at least two directions comprise the at least one direction.

Similarly, the first acquiring unit 542 can acquire the visualized content by communicating with at least one capturing unit corresponding to each direction, or by positively capturing the visualized content of the target scene in the at least one direction.

The sending unit 544 is configured to send the visualized content associated with the target scene in the at least one direction to the user. Specifically, the sending unit 544 sends the visualized content to a device, for example a helmet mounted display, glasses, etc., worn by the user, for presenting immersive virtual reality display at user side.

Further as abovementioned, the sending strategy further comprises: sending the visualized content associated with the target scene in the at least two directions to the user at least according to a preset priority, wherein the at least two directions comprise the at least one direction. In such an example embodiment:

The sending unit 544 is configured to acquire the visualized content associated with the target scene in the at least two directions.

Similarly, the sending unit 544 can acquire the visualized content by communicating with at least one capturing unit corresponding to each direction, or positively capturing the visualized content of the target scene in the at least one direction.

The sending unit 544 is configured to send the visualized content associated with the target scene in the at least two directions according to the preset priority. Specifically, the sending unit 544 sends the visualized content to a device, for example a helmet mounted display, glasses, etc., worn by the user, for presenting immersive virtual reality display at user side.

In addition, in an immersive virtual reality scenario, the user gesture can be tracked by a plurality of sensors, and the apparatus of the embodiment can acquire the information associated with the user gesture from the at least one sensor associated with the user. Therefore, the third acquiring module can receive the information of the at least one sensor associated with the user. The information can be original sensor data sensed by each sensor or a definite user gesture determined by the sensor data sensed by each sensor.

In conclusion, in the apparatus of this embodiment, compared with the visualized content to be sent used for forming the virtual reality display, the information associated with the user gesture and sending strategy can be sent in smaller data packets with low transmission requirements, through such tracking feedback mechanism, the visualized content can be transmitted in a more intelligent manner, and better immersive experience is provided for the user even under the condition of a limited bandwidth.

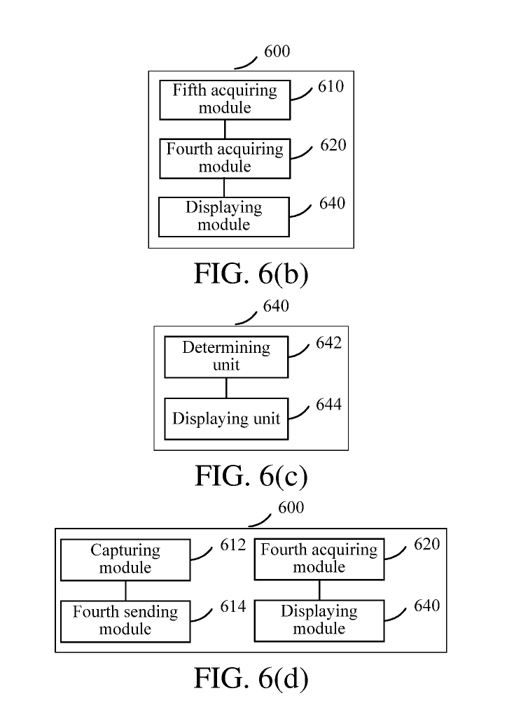

An embodiment of the present application further provides an apparatus executing the presenting method as described in combination with FIG. 3, the apparatus can be a virtual reality display apparatus, and such virtual reality display apparatus comprises but is not limited to a helmet mounted display, a projection device of a projection virtual reality system, etc. Besides each constituting part described below, the apparatus can further comprise a communicating module capable of communicating with any external device as required. As shown in FIG. 6(a), a presenting apparatus 600 in this embodiment comprises:

a fourth acquiring module 620, configured to acquire visualized content sent according to a sending strategy, wherein the sending strategy is determined according to information associated with a user gesture, and comprises: sending visualized content associated with a target scene in at least one direction corresponding to the user gesture to the user.

As described in combination with FIG. 1, in order to more intelligently send the visualized content, a capturing unit sends the visualized content according to certain sending strategy. The fourth acquiring module 620 is configured to acquire such visualized content.

A displaying module 640, configured to present immersive virtual reality display to the user at least according to the sending strategy.

The sending strategy clarifies that the sent visualized content is related to a state and/or intention in a process that a user views the immersive virtual reality display, and therefore the apparatus in this embodiment can provide better experience for the user.

Specifically, in order to more intelligently present the immersive virtual reality display for the user, as shown in FIG. 6(b), the apparatus 600 in this embodiment can further comprise:

A fourth acquiring module 610, configured to acquire information associated with the sending strategy. For example, the fourth acquiring module 610 receives the information associated with the sending strategy sent from an apparatus executing the method in the embodiment described in FIG. 1.

As shown in FIG. 6(c), the displaying module 640 can further comprise: a determining unit 642 and a displaying unit 644.

As described in FIG. 1, in an example embodiment, in order to save bandwidth would otherwise be used for sending the visualized content in multiple directions, thereby transmitting the visualized content in the at least one direction with higher transmission quality, the sending strategy clearly denotes: only sending the visualized content associated with the target scene in the at least one direction. In such an example embodiment:

The determining unit 642 is configured to determine the at least one direction at least according to the sending strategy.

The displaying unit 644 is configured to present the immersive virtual reality to the user at least according to visualized content in the at least one direction acquired at a latest moment and visualized content in other directions acquired at a previous moment.

In order to provide immersive experience, visualized content in multiple directions may be required to be combined when the immersive virtual reality display is formed, therefore, in addition to the visualized content in the at least one direction, historical data can be used as the corresponding visualized content in other directions, thus ensuring the real time and/or high quality in a user viewing direction while ensuring the immersive experience.

In another example embodiment, the sending strategy can further clearly denote: sending the visualized content associated with the target scene in the at least one direction to the user according to a preset priority, and specifically, the sending strategy can comprise: sending the visualized content associated with the target scene in the at least one direction corresponding to the user gesture with higher priority. The higher priority comprises but is not limited to higher sending frequency priority, sending time priority, transmission quality priority and the like, that is, compared with the visualized content in other directions, the visualized content associated with the target scene in the at least one direction can be sent earlier, and more frequently within a unit time and/or with higher transmission quality, thus ensuring user experience. In such an example embodiment:

the ninth determining unit 642 is configured to determine the preset priority at least according to the sending strategy.

The displaying unit 644 is configured to present the immersive virtual reality to the user according to the preset priority.

In an example embodiment, the apparatus in this embodiment can determine the acquirable visualized content direction according to the preset priority, and combines with the historical data in other directions to present the immersive virtual reality to the user.

In addition, in order to provide a reference determining the sending strategy, as shown in FIG. 6(d), the apparatus 600 in this embodiment further comprises:

a capturing module 612, configured to capture information associated with a user gesture, in one example embodiment, capturing module 612 captures the user gesture by at least one sensor, and in one example embodiment, the capturing module 612 comprises the at least one sensor or the at least one sensor belongs to the apparatus of this embodiment.

a fourth sending module 614, configured to send the information associated with the user gesture, wherein the information can be raw sensor data sensed by each sensor or a definite user gesture determined according to the sensor data sensed by each sensor. The fourth sending module 614 can, in combination with the apparatus executing the method as described in FIG. 1 and/or the apparatus executing the method as described in FIG. 2, send the information in a manner that the first information can be received.

It should be noted that the apparatus in this embodiment can adopt any proper technology, provide virtual reality display for the use based on the acquired visualized content and is not limitative to technical solutions of the embodiment of the present application.

In conclusion, the apparatus in this embodiment can provide well immersive virtual reality viewing experience for the user.

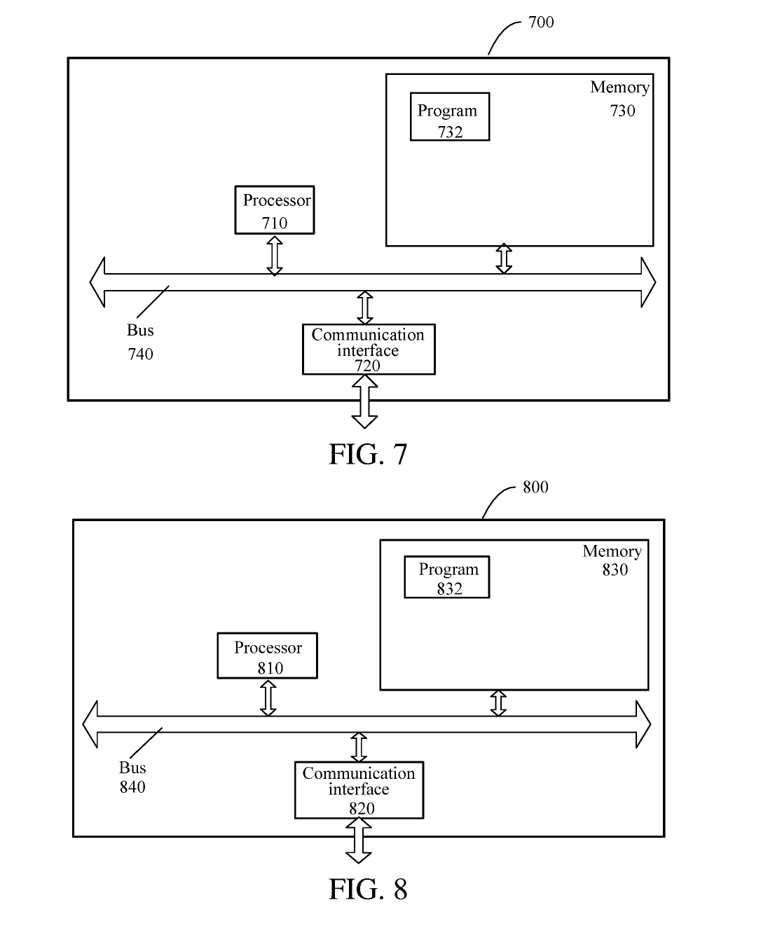

FIG. 7 is a structural diagram of another example of a visualized content transmission control apparatus according to an embodiment of the present application; and a specific embodiment of the present application does not limit implementation of the visualized content transmission control apparatus. As shown in FIG. 7, the visualized content transmission control apparatus 700 can comprise:

a processor 710, a communication interface 720, a memory 730 and a communication bus 740, wherein,

the processor 710, the communication interface 720 and the memory 730 communicate with one another by the communication bus 740.

The communication interface 720 is configured to communicate with a network element such as a client end.

The processor 710 is configured to execute a program 732 and specifically execute related steps in the embodiments of foregoing method.

Specifically, the program 732 can comprise a program code, comprising a computer operation command.

The processor 710 can be a CPU or an ASIC (Application Specific Integrated Circuit), or is configured to be one or more integrated circuits to execute the embodiments of the present application.

The memory 730 is configured to store the program 732. The memory 730 possibly contains a high speed Ram memory and possibly further comprises a non-volatile memory, for example, at least one disk memory. The program 732 is specifically configured to enable the visualized content transmission control apparatus 700 to execute following steps:

acquiring information associated with a user gesture; and

determining a sending strategy of visualized content associated with a target scene at least according to the information associated with the user gesture, wherein the sending strategy comprises: sending visualized content associated with the target scene in at least one direction corresponding to the user gesture to the user.

The steps in the program 732 refers to the corresponding descriptions of corresponding steps and units in the foregoing embodiments, which are not repeated herein. It may be clearly understood by a person skilled in the art that, for the purpose of convenient and brief description, reference may be made to the description of corresponding procedures in the foregoing method embodiments for detailed working procedures of the foregoing devices and modules, and details are not repeated herein.

FIG. 8 is a structural diagram of another example of a visualized content sending apparatus according to an embodiment of the present application; and a specific embodiment of the present application does not limit implementation of the visualized content sending apparatus. As shown in FIG. 8, the visualized content sending apparatus 800 can comprise:

a processor 810, a communication interface 820, a memory 830 and a communication bus 840, wherein,

the processor 810, the communication interface 820 and the memory 830 communicate with one another by the communication bus 840.

The communication interface 820 is configured to communicate with a network element such as a client end.

The processor 810 is configured to execute a program 832 and specifically execute related steps in the embodiments of foregoing method.

Specifically, the program 832 can comprise a program code, comprising a computer operation command.

The processor 810 can be a CPU or an ASIC (Application Specific Integrated Circuit), or is configured to be one or more integrated circuits to execute the embodiments of the present application.

The memory 830 is configured to store the program 832. The memory 830 possibly contains a high speed Ram memory and possibly further comprises a non-volatile memory, for example, at least one disk memory. The program 832 is specifically configured to enable the visualized content sending apparatus 800 to execute following steps:

acquiring information associated with a user gesture; and

sending visualized content associated with a target scene in at least one direction corresponding to the user gesture to the user at least according to the information associated with the user gesture.

The steps in the program 832 refer to the corresponding descriptions of corresponding steps and units in the foregoing embodiments, which are not repeated herein. It may be clearly understood by a person skilled in the art that, for the purpose of convenient and brief description, reference may be made to the description of corresponding procedures in the foregoing method embodiments for detailed working procedures of the foregoing devices and modules, and details are not repeated herein.

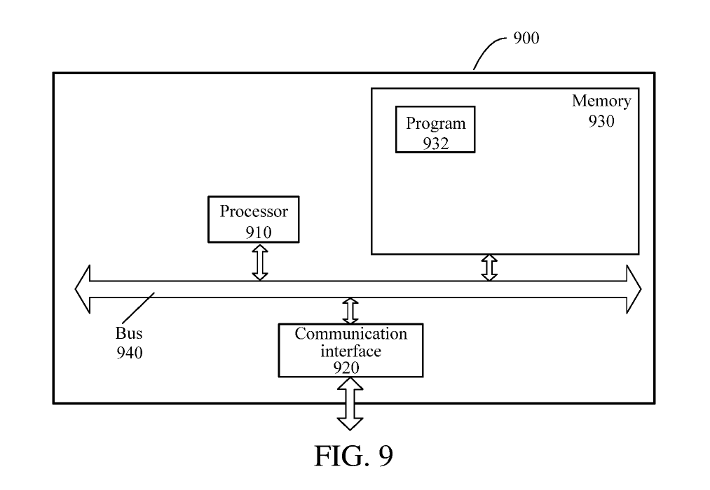

FIG. 9 is a structural diagram of another example of a presenting apparatus according to an embodiment of the present application; and a specific embodiment of the present application does not limit implementation of the presenting apparatus. As shown in FIG. 9, the presenting apparatus 900 can comprise:

a processor 910, a communication interface 920, a memory 930 and a communication bus 940, wherein,

the processor 910, the communication interface 920 and the memory 930 communicate with one another by the communication bus 940.

The communication interface 920 is configured to communicate with a network element such as a client end.

The processor 910 is configured to execute a program 932 and specifically execute related steps in the embodiments of foregoing method.

Specifically, the program 932 can comprise a program code, comprising a computer operation command.

The processor 910 can be a CPU or an ASIC (Application Specific Integrated Circuit), or is configured to be one or more integrated circuits to execute the embodiments of the present application.

The memory 930 is configured to store the program 932. The memory 930 possibly contains a high speed Ram memory and possibly further comprises a non-volatile memory, for example, at least one disk memory. The program 932 is specifically configured to enable the presenting apparatus 900 to execute following steps:

acquiring visualized content sent according to a sending strategy, wherein the sending strategy is determined according to information associated with a user gesture, and comprises: sending visualized content associated with a target scene in at least one direction corresponding to the user gesture to the user; and

presenting immersive virtual reality display to the user at least according to the sending strategy.

The steps in the program 932 refer to the corresponding descriptions of corresponding steps and units in the foregoing embodiments, which are not repeated herein. It may be clearly understood by a person skilled in the art that, for the purpose of convenient and brief description, reference may be made to the description of corresponding procedures in the foregoing method embodiments for detailed working procedures of the foregoing devices and modules, and details are not repeated herein.

It can be appreciated by a person of ordinary skill in the art that, exemplary units and method steps described with reference to the embodiments disclosed in this specification can be implemented by electronic hardware or a combination of computer software and electronic hardware. Whether these functions are executed by hardware or software depends on specific applications and design constraints of the technical solution. A person skilled in the art may use different methods to implement the described functions for each specific application, but such example embodiment should not be construed as a departure from the scope of the present application.

If the function is implemented in the form of a software functional unit and is sold or used as an independent product, the product can be stored in a computer-readable storage medium. Based on this understanding, the technical solution of the present application essentially, or the part that contributes to the prior art, or a part of the technical solution may be embodied in the form of a software product; the computer software product is stored in a storage medium and comprises several instructions for enabling a computer device (which may be a personal computer, a server, a network device, or the like) to execute all or some of the steps of the method in the embodiments of the present application. The foregoing storage medium comprises a USB flash drive, a removable hard disk, a read-only memory (ROM), a random access memory (RAM), a diskette or a compact disk that can be configured to store a program code.

The above example embodiments are only used to describe the present application, rather than limit the present application; various alterations and variants can be made by those of ordinary skill in the art without departing from the spirit and scope of the present application, so all equivalent technical solutions also belong to the scope of the present application, and the scope of patent protection of the present application should be defined by claims.

What is claimed is:

1. A method, comprising:
acquiring, by a system comprising a processor, information associated with a user gesture; and
determining a sending strategy of visualized content associated with a target scene at least according to the information associated with the user gesture, wherein the sending strategy comprises: sending, to the user, the visualized content associated with the target scene in a direction corresponding to the user gesture.

2. The method of claim 1, wherein the determining the sending strategy of the visualized content associated with the target scene comprises:
determining the direction at least according to the information associated with the user gesture.

3. The method of claim 1, further comprising:
acquiring the visualized content associated with the target scene in the direction at least according to the sending strategy; and
sending the visualized content associated with the target scene in the direction to the user.

4. The method of claim 1, further comprising:
acquiring visualized content associated with the target scene in at least two directions at least according to the sending strategy, wherein the at least two directions comprise the at least one direction; and
sending the visualized content associated with the target scene in the at least one direction to the user.

5. The method of claim 1, wherein the sending strategy further comprises: sending the visualized content associated with the target scene in at least two directions to the user at least according to a preset priority, wherein the at least two directions comprise the direction; and wherein the method further comprises:
acquiring the visualized content associated with the target scene in the at least two directions at least according to the sending strategy; and
sending the visualized content associated with the target scene in the at least two directions according to the preset priority.

6. The method of claim 5, wherein the preset priority comprises a sending frequency priority, a sending time priority, or a transmission quality priority.

7. The method of claim 1, wherein the acquiring the information associated with the user gesture comprises:
receiving the information from at least one sensor associated with the user.

8. The method of claim 1, further comprising:
sending information associated with the sending strategy.

9. The method of claim 1, wherein the information associated with the user gesture comprises information associated with at least one of a user facing direction, a user head rotation speed, a user head horizontal angle or a user head tilt angle.

10. A method, comprising:
acquiring, by a system comprising a processor, information associated with a user gesture; and
sending visualized content associated with a target scene in at least one direction corresponding to the user gesture to the user at least according to the information associated with the user gesture.

11. The method of claim 10, further comprising:
determining the at least one direction at least according to the information associated with the user gesture.

12. The method of claim 11, wherein the sending the visualized content associated with the target scene in the at least one direction corresponding to the user gesture to the user comprises:
acquiring the visualized content associated with the target scene in the at least one direction; and
sending the visualized content associated with the target scene in the at least one direction to the user.

13. The method of claim 11, wherein the sending the visualized content associated with the target scene in the at least one direction corresponding to the user gesture to the user comprises:
acquiring the visualized content associated with the target scene in at least two directions, wherein the at least two directions comprise the at least one direction; and
sending the visualized content associated with the target scene in the at least two directions to the user.

14. The method of claim 11, wherein the sending strategy further comprises: sending the visualized content associated with the target scene in at least two directions to the user according to the preset priority, wherein the at least two directions comprise the at least one direction, and
wherein the sending the visualized content associated with the target scene in the at least one direction corresponding to the user gesture to the user comprises:
acquiring the visualized content associated with the target scene in the at least two directions; and
sending the visualized content associated with the target scene in the at least two directions to the user according to the present priority.

15. The method of claim 14, wherein the preset priority comprises a sending frequency priority, a sending time priority, or a transmission quality priority.

16. The method of claim 10, wherein the acquiring the information associated with the user gesture comprises:
receiving the information from at least one sensor associated with the user.

17. The method of claim 16, wherein the information associated with the user gesture comprises information associated with at least one of a user facing direction, a user head rotation speed, a user head horizontal angle or a user head tilt angle.

18. A method, comprising:
acquiring, by a system comprising a processor, visualized content sent according to a sending strategy, wherein the sending strategy is determined according to gesture information associated with a user gesture, and comprises: sending the visualized content associated with a target scene in at least one direction corresponding to the user gesture to the user; and
presenting an immersive virtual reality display to the user at least according to the sending strategy.

19. The method of claim 18, further comprising:
acquiring strategy information associated with the sending strategy.

20. The method of claim 18, wherein the presenting the immersive virtual reality display to the user at least according to the sending strategy comprises:
determining the at least one direction at least according to the sending strategy; and
presenting the immersive virtual reality to the user at least according to the visualized content in the at least one direction acquired at a latest moment and previous visualized content in another direction acquired at a previous moment.

21. The method of claim 18, wherein the sending strategy further comprises: sending the visualized content associated with the target scene in at least two directions to the user according to a preset priority, wherein the at least two directions comprise the at least one direction, and
wherein the presenting the immersive virtual reality display to the user at least according to the sending strategy comprises:
determining the preset priority at least according to the sending strategy; and
presenting the immersive virtual reality to the user according to the preset priority.

22. The method of claim 20, wherein the preset priority comprises a sending frequency priority, a sending time priority, or a transmission quality priority.

23. The method of claim 18, further comprising:
capturing the gesture information associated with the user gesture; and
sending the gesture information associated with the user gesture.

24. The method of claim 22, wherein the gesture information associated with the user gesture comprises information associated with at least one of a user facing direction, a user head rotation speed, a user head horizontal angle or a user head tilt angle.

25. An apparatus, comprising:
a memory that stores executable modules; and
a processor, coupled to the memory, that executes or facilitates execution of the executable modules, the executable modules comprising:
a first acquiring module configured to acquire first information associated with a user gesture; and
a first determining module configured to determine a sending strategy of visualized content associated with a target scene at least according to the first information associated with the user gesture, wherein the sending strategy comprises: sending the visualized content associated with the target scene in at least one direction corresponding to the user gesture to the user.

26. The apparatus of claim 25, wherein the first acquiring module is configured to determine the at least one direction at least according to the first information associated with the user gesture.

27. The apparatus of claim 25, wherein the executable modules further comprise:
a second acquiring module configured to acquire the visualized content associated with the target scene in the at least one direction at least according to the sending strategy; and
a first sending module configured to send the visualized content associated with the target scene in the at least one direction to the user.

28. The apparatus of claim 25, wherein the executable modules further comprise:
a second acquiring module configured to acquire the visualized content associated with the target scene in at least two directions at least according to the sending strategy, wherein the at least two directions comprise the at least one direction; and
a first sending module configured to send the visualized content associated with the target scene in the at least one direction to the user.

29. The apparatus of claim 25, wherein the sending strategy further comprises: sending the visualized content associated with the target scene in at least two directions to the user at least according to a preset priority, wherein the at least two directions comprise the at least one direction, and
wherein the executable modules further comprise:
a second acquiring module configured to acquire the visualized content associated with the target scene in the at least two directions at least according to the sending strategy; and
a first sending module configured to send the visualized content associated with the target scene in the at least two directions according to the preset priority.

30. The apparatus of claim 25, wherein the first acquiring module is configured to receive the first information from at least one sensor associated with the user.

31. The apparatus of claim 25, wherein the executable modules further comprise:
a first sending module configured to send second information associated with the sending strategy.

32. An apparatus, comprising:
a memory that stores executable modules; and
a processor, coupled to the memory, that executes or facilitates execution of the executable modules, the executable modules comprising:
a first acquiring module configured to acquire information associated with a user gesture; and
a first sending module configured to send visualized content associated with a target scene in at least one direction corresponding to the user gesture to the user at least according to the information associated with the user gesture.

33. The apparatus of claim 32, wherein the first sending module is configured to determine the at least one direction at least according to the information associated with the user gesture.

34. The apparatus of claim 33, wherein the first sending module comprises:
a first acquiring unit configured to acquire the visualized content associated with the target scene in the at least one direction; and
a sending unit configured to send the visualized content associated with the target scene in the at least one direction to the user.

35. The apparatus of claim 33, wherein the first sending module comprises:
a first acquiring unit configured to acquire the visualized content associated with the target scene in at least two directions, wherein the at least two directions comprise the at least one direction; and
a sending unit configured to send the visualized content associated with the target scene in the at least two directions to the user.

36. The apparatus of claim 33, wherein the sending strategy further comprises: sending the visualized content associated with the target scene in at least two directions according to a preset priority to the user, wherein the at least two directions comprise the at least one direction, and
wherein the first sending module comprises:
a first acquiring unit configured to acquire the visualized content associated with the target scene in the at least two directions; and
a sending unit configured to send the visualized content associated with the target scene in the at least two directions to the user according to the preset priority.

37. The apparatus of claim 32, wherein the first sending module is configured to receive the information from at least one sensor associated with the user.

38. An apparatus, comprising:
a memory that stores executable modules; and
a processor, coupled to the memory, that executes or facilitates execution of the executable modules, the executable modules comprising:
a first acquiring module configured to acquire visualized content sent according to a sending strategy, wherein the sending strategy is determined according to information associated with a user gesture, and wherein the sending strategy comprises: sending the visualized content associated with a target scene in at least one direction corresponding to the user gesture to the user; and
a displaying module configured to present an immersive virtual reality display to the user at least according to the sending strategy.

39. The apparatus of claim 38, wherein the executable modules further comprise:
a second acquiring module configured to acquire other information associated with the sending strategy.

40. The apparatus of claim 38, wherein the displaying module comprises:
a determining unit configured to determine the at least one direction at least according to the sending strategy; and
a displaying unit configured to present the immersive virtual reality to the user at least according to the visualized content in the at least one direction acquired at a latest moment and previous visualized content in another direction acquired at a previous moment.

41. The apparatus of claim 38, wherein the sending strategy further comprises: sending the visualized content associated with the target scene in at least two directions according to a preset priority, wherein the at least two directions comprise the at least one direction, and
wherein the displaying module comprises:
a determining unit configured to determine the preset priority at least according to the sending strategy; and
a displaying unit configured to present the immersive virtual reality to the user according to the preset priority.

42. The apparatus of claim 38, wherein the executable modules further comprise:
a capturing module configured to capture the information associated with the user gesture; and
a sending module configured to send the information associated with the user gesture.

43. An apparatus, comprising:
a video camera comprising a plurality of cameras;
a memory configured to store a command;
a processor configured to execute the command stored by the memory, wherein the command enables the processor to execute operations, comprising:
acquiring information associated with a user gesture; and
determining a sending strategy of visualized content associated with a target scene at least according to the information associated with the user gesture, wherein the sending strategy comprises: sending, to the user, the visualized content associated with the target scene in a direction corresponding to the user gesture by at least one of the plurality of cameras.

44. An apparatus, comprising:
a display;
a memory configured to store a command; and
a processor configured to execute the command stored by the memory, wherein the command enables the processor to execute operations, comprising:
acquiring visualized content sent according to a sending strategy, wherein the sending strategy is determined according to information associated with a user gesture, and comprises: sending the visualized content associated with a target scene in at least one direction corresponding to the user gesture; and
presenting an immersive virtual reality display to the user via the display at least according to the sending strategy.
